(19) United States
(12) Patent Application Publication
(10) Pub. No.: US 2020/0074365 A1
(43) Pub. Date: Mar. 5, 2020

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Akihiko NAKANISHI, Nisshin-shi (JP); Daigo FUJII, Tsushima-shi (JP); Makoto TANAKA, Toyota-shi (JP); Kazuki TAKEUCHI, Toyota-shi (JP); Chie KOIKE, Nagoya-shi (JP); Daiki KANEICHI, Nisshin-shi (JP); Tsuyoshi OKADA, Toyota-shi (JP)

(73) Assignee: TOYOTA JIDOSHA KABUSHIKI KAISHA, Toyota-shi (JP)

(21) Appl. No.: 16/555,191

(22) Filed: Aug. 29, 2019

(30) Foreign Application Priority Data
Sep. 4, 2018 (JP) 2018-165019

(51) Int. Cl. G06Q 10/06; G06Q 30/02

(52) U.S. Cl. CPC G06Q 10/06311; G06Q 30/0207

(57) ABSTRACT

An information processing apparatus includes a controller configured to: for each of ride-joining wishing users, acquire a schedule information piece relating to travel using ride sharing, the travel being desired by the user; if it is predicted that a plurality of the ride-joining wishing users can be matched with a first vehicle that is one of vehicles corresponding to the vehicle, based on the schedule information pieces, set a predetermined priority for the matching, for each of the plurality of ride-joining wishing users; and perform matching between the first vehicle and the ride-joining wishing users in such a manner that from among the plurality of ride-joining wishing users with the respective predetermined priorities set therefor, a user whose priority is high is matched with the first vehicle in preference to a user whose priority is low.

### CROSS-REFERENCE TO RELATED APPLICATIONS

This application claims the benefit of Japanese Patent Application No. 2018-165019, filed on Sep. 4, 2018, which is hereby incorporated by reference herein in its entirety.

### BACKGROUND

### Technical Field

The present disclosure relates to an information processing apparatus, an information processing method and a non-transitory storage medium.

### Description of the Related Art

In recent years, use of what is called ride sharing, which is a form of transportation in which a plurality of users share a ride in a same vehicle, has been prevailing. Also, for use of such ride sharing, techniques for matching a plurality of users with each other has been developed.

Also, patent document 1 discloses a technique for determining whether or not respective owners of terminals share a ride in a same vehicle.

### CITATION LIST

### Patent Literature

Patent Literature Japanese Patent Laid-Open No. 2011-237842

### SUMMARY

An object of the present disclosure is to provide an information processing apparatus, an information processing method and a program that enable provision of a form of transportation in which a plurality of users ride in a same vehicle for travel, the form of transportation being easy for a user to use.

An information processing apparatus according to the present disclosure is an information processing apparatus for, in a form of transportation in which a plurality of users ride in a same vehicle for travel, performing matching between the vehicle and ride-joining wishing users each wishing to join a ride in the vehicle as a non-driving user. The information processing apparatus comprises a controller including at least one processor. The controller is configured to:

for each of the ride-joining wishing users, acquire a schedule information piece relating to travel using the form of transportation, the travel being desired by the user;

if it is predicted that a plurality of the ride-joining wishing users can be matched with a first vehicle that is a vehicle corresponding to the vehicle, based on the schedule information pieces, set a predetermined priority for the matching, for each of the plurality of ride-joining wishing users; and

perform matching between the first vehicle and the ride-joining wishing users in such a manner that from among the plurality of ride joining wishing users with the respective predetermined priorities set therefor, a user whose priority is high, is matched with the first vehicle in preference to a user whose priority is low.

Also, an aspect of the present disclosure can provide an information processing method. For example, the present disclosure may provide an information processing method for, in a form of transportation in which a plurality of users ride in a same vehicle for travel, performing matching between the vehicle and ride-joining wishing users each wishing to join a ride in the vehicle as a non-driving user. In such a case, the information processing method may be adapted to cause a computer to execute the steps of

for each of the ride-joining wishing users, acquiring a schedule information piece relating to travel using the form of transportation, the travel being desired by the user;

if it is predicted that a plurality of the ride-joining wishing users can be matched with a first vehicle that is a vehicle corresponding to the vehicle, based on the schedule information pieces, setting a predetermined priority for the matching, for each of the plurality of ride-joining wishing users; and

performing matching between the first vehicle and the ride-joining wishing users in such a manner that from among the plurality of ride-joining wishing users with the respective predetermined priorities set therefor, a user whose priority is high, is matched with the first vehicle in preference to a user whose priority is low. Then, the present disclosure may provide a program for causing a computer to perform such information processing method or a non-transitory storage medium with the program stored therein.

The present disclosure enables provision of a form of transportation in which a plurality of users ride in a same vehicle for travel, the form of transportation being easy for a user to use.

### BRIEF DESCRIPTION OF DRAWINGS

FIG. 1 is a diagram illustrating a schematic configuration of an information processing system according to an embodiment;

FIG. 2 is a diagram illustrating respective hardware configurations of a user terminal, a driving user terminal and a server apparatus in an information processing system;

FIG. 3 is a diagram illustrating a functional configuration of a server apparatus according to an embodiment;

FIG. 4 is a diagram illustrating an example of a running schedule information table according to an embodiment;

FIG. 5 is a diagram illustrating an example of a desired schedule information table according to a first embodiment;

FIG. 6 is a diagram illustrating a positional relationship of spots “a” to “h” illustrated in FIGS. 4 and 5;

FIG. 7 is a diagram illustrating user ranks given to users using an information processing system according to the first embodiment;

FIG. 8 is a diagram illustrating user ranks given to ride joining wishing users C001 to C006;

FIG. 9 is a diagram illustrating predetermined priorities set based on the user ranks illustrated in FIG. 8;

FIG. 10 is a diagram illustrating an example of a matching information table according to the first embodiment;

FIG. 11 is a flowchart of processing performed by a server apparatus;

FIG. 12 is a diagram illustrating an example of a desired schedule information table according to a second embodiment;

FIG. 13 is a diagram illustrating predetermined priorities in the second embodiment; and

FIG. 14 is a diagram illustrating an example of a matching information table according to the second embodiment.

### DESCRIPTION OF EMBODIMENTS

An information processing apparatus, which is provided by an aspect of the present disclosure performs, in a form of transportation in which a plurality of users ride in a same vehicle for travel (ride sharing), matching between a vehicle and users each wishing to join a ride in the vehicle as a non-driving user (hereinafter, referred to as “ride-joining wishing user(s)”) based on predetermined priorities. More specifically, the information processing apparatus according to the present disclosure performs matching between a vehicle and a plurality of ride-joining wishing users with respective predetermined priorities set therefor in such a manner that from among the ride-joining wishing users, a user whose priority is high, is matched with the vehicle in preference to a user whose priority is low.

Here, the predetermined priorities are respective priorities for matching of the plurality of ride-joining wishing users with a first vehicle that is a vehicle corresponding to the vehicle and are set for the plurality of ride-joining wishing users, respectively. In other words, each of the predetermined priorities is an index indicating a degree of easiness of matching of a relevant one of the plurality of ride-joining wishing users with the first vehicle. The predetermined priorities may be set based on respective predetermined ranks set in advance for users of ride sharing or may be set based on respective intention information pieces each relating to a predetermined intention indication, from the plurality of ride-joining wishing users that can be matched with the first vehicle.

Consequently, a ride-joining wishing user can grasp whether or not the ride-joining wishing user is likely to be matched with the first vehicle, based on, e.g., the user's own user rank. Therefore, the information processing apparatus according to the present disclosure enables provision of a form of transportation in which a plurality of users ride in a same vehicle for transportation, the form of transportation being easy for a user to use.

Specific embodiments of the present disclosure will be described below with reference to the drawings. Unless otherwise stated, the dimensions, the materials, shapes, relative dispositions, etc., of the components described in the below embodiments are not intended to limit the technical scope of the present disclosure thereto.

### First Embodiment

(System Configuration)

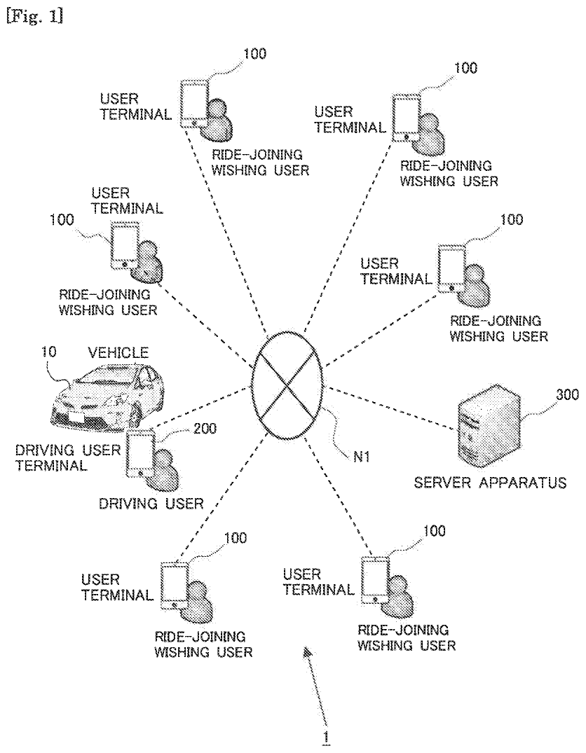

FIG. 1 is a diagram illustrating a schematic configuration of an information processing system according to the present embodiment. In the example in FIG. 1, an information processing system 1 includes a vehicle 10, user terminals 100 owned by respective users (ride-joining wishing users) each wishing to join a ride in the vehicle 10 as a non-driving user, a driving user terminal 200, which is a terminal owned by a driving user who drives the vehicle 10, and a server apparatus 300. Note that ride sharing according to the present embodiment is an example in a case where there are a number of ride-joining wishing users, the number being larger than a ride-sharing capacity of a vehicle 10 (corresponding to a first vehicle according to the present disclosure), and there is a number of user terminals 100, the number corresponding to the number of ride-joining wishing users.

In the information processing system 1, the respective user terminals 100, the driving user terminal 200 and the server apparatus 300 are interconnected via a network N1. For the network N1, for example, a WAN (wide area network), which is a worldwide public communication network such as the Internet, or another communication network. Also, the network N1 may include a telephone communication network for, e.g., mobile phones and/or a wireless communication network such as Wi-Fi.

Each ride-joining wishing user can input information of a request for travel using ride-sharing, using his/her user terminal 100. In the present embodiment, each ride-joining wishing user inputs schedule information relating to travel using ride sharing, the travel being desired by the user (hereinafter, may be referred to as “desired schedule information”). Here, in each user terminal 100, a predetermined application for using the information processing system 1 (hereinafter may be referred to “predetermined app”) has been installed, and each ride-joining wishing user can input desired schedule information using the predetermined app installed in his/her user terminal 100. Also, the driving user who drives the vehicle 10 (first vehicle) provided for ride sharing in the information processing system 1 can input running schedule of the vehicle 10 (hereinafter may be referred to as “running schedule information”) using the driving user terminal 200. The running schedule information can be input using the predetermined app installed in the driving user terminal 200. Note that the desired schedule information or the running schedule information may be input using an arbitrary terminal (e.g., a smartphone, a mobile phone, a tablet terminal, a personal information terminal or a wearable computer) or a personal computer (PC) that is connectable to the network N1.

The server apparatus 300 is a management server that manages matching between vehicles and ride-joining wishing users. Here, according to matching processing based on desired schedule information and running schedule information using a known technique, in the information processing system 1 illustrated in FIG. 1, six ride-joining wishing users can be matched with the vehicle 10 (first vehicle). However, if a riding capacity of the vehicle 10 is five people, four of the six ride-joining wishing users can ride in the vehicle 10. In this case, it is unclear which users of the six ride-joining wishing users can actually ride in the vehicle 10. Then, each ride-joining wishing users may worry about whether or not he/she can travel using ride sharing. Therefore, the server apparatus 300 performs matching between the vehicle 10 (first vehicle) and the ride-joining wishing users based on predetermined priorities. Details of matching processing according to the present embodiment will be described later.

(Hardware Configuration)

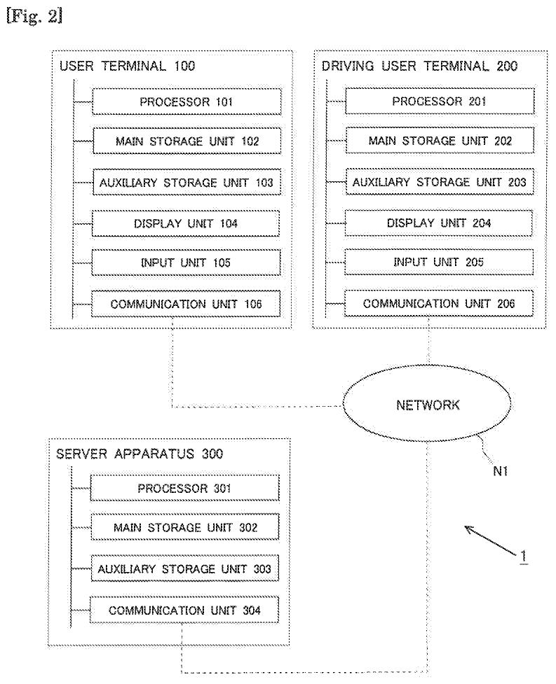

FIG. 2 is a diagram illustrating respective hardware configurations of a user terminal 100, the driving user terminal 200 and the server apparatus 300.

First, the server apparatus 300 will be described. The server apparatus 300 has a configuration of a general computer. The server apparatus 300 includes a processor 301, a main storage unit 302, an auxiliary storage unit 303 and a communication unit 304. These components are interconnected via a bus. Each of the main storage unit 302 and the auxiliary storage unit 303 is a computer-readable storage medium. The hardware configuration of the computer is not limited to the example illustrated in FIG. 2 and appropriate omission, replacement and/or addition of components are possible.

In the server apparatus 300, the processor 301 loads a program stored in a storage medium to a work area of the main storage unit 302 and executes the program, and the respective functional units and the like are controlled through the execution of the program, enabling provision of functions meeting a predetermined purpose.

The processor 301 is, for example, a CPU (central processing unit) or a DSP (digital signal processor). The processor 301 controls the server apparatus 300 and performs various arithmetic operations for information processing. The main storage unit 302 includes, for example, a RAM (random access storage) and a ROM (read-only storage). The auxiliary storage unit 303 is, for example, an EPROM (erasable programmable ROM) or a hard disk drive (HDD). Also, the auxiliary storage unit 303 can include a removable medium, that is, a removable storage medium. The removable medium is, for example, a USB (universal serial bus) memory or a disk storage medium such as a CD (compact disc) or a DVD (digital versatile disc).

The auxiliary storage unit 303 stores various programs, various data and various tables in a storage medium in such a manner that programs, data and tables can be read/written. In the auxiliary storage unit 303, e.g., an operating system (OS), various programs and various tables are stored. Information to be stored in the auxiliary storage unit 303 may be stored in the main storage unit 302. Also, information to be stored in the main storage unit 302 mat be stored in the auxiliary storage unit 303.

The communication unit 304 connects to another apparatus and controls communication between the server apparatus 300 and the other apparatus. The communication unit 304 is, for example, a LAN (local area network) interface board or a wireless communication circuit for wireless communication. The LAN interface board or the wireless communication circuit is connected to the network N1 such as the Internet, which is a public communication network.

A series of processing performed by the server apparatus 300 can be performed by hardware but can also be performed by software.

Next, the user terminal 100 will be described. The user terminal 100 is, for example, a compact computer such as a smartphone, a mobile phone, a tablet terminal, a personal information terminal or a wearable computer (e.g., a smart watch). Note that the user terminal 100 may be a personal computer (PC) connected to the server apparatus 300 via the network N1 such as the Internet, which is a public communication network.

The user terminal 100 includes a processor 101, a main storage unit 102, an auxiliary storage unit 103, a display unit 104, an input unit 105 and a communication unit 106. The processor 101, the main storage unit 102 and the auxiliary storage unit 103 are similar to the processor 301, the main storage unit 302 and the auxiliary storage unit 303 of the server apparatus 300, respectively, and thus, description thereof will be omitted. The display unit 104 is, for example, an LCD (liquid-crystal display) or an EL (electroluminescence) panel. The input unit 105 includes, e.g., a touch panel and/or push buttons. Also, the input unit 105 can include a camera that enables an input of video or an image and an audio input unit such as a microphone. The communication unit 106 is, for example, a communication circuit for accessing the network N1 using a telephone communication network for, e.g., mobile phones or wireless communication network such as Wi-Fi, and performing data communication with, e.g., the server apparatus 300.

Next, the driving user terminal 200 will be described. As with the user terminal 100, the driving user terminal 200 includes a processor 201, a main storage unit 202, an auxiliary storage unit 203, a display unit 204, an input unit 205 and a communication unit 206. The processor 201, the main storage unit 202, the auxiliary storage unit 203, the display unit 204, the input unit 205 and the communication unit 206 are similar to the processor 101, the main storage unit 102, the auxiliary storage unit 103, the display unit 104, the input unit 105 and the communication unit 106 of the user terminal 100, respectively, and thus, description thereof will be omitted.

(Functional Configuration of Server Apparatus)

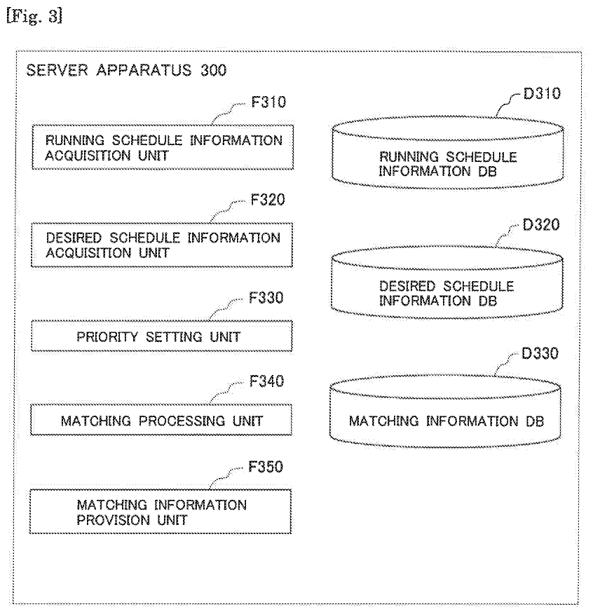

FIG. 3 is a diagram illustrating a functional configuration of the server apparatus 300. The server apparatus 300 includes a running schedule information acquisition unit F310, a desired schedule information acquisition unit F320, a priority setting unit F330, a matching processing unit F340, a matching information provision unit F350, a running schedule information database D310, a desired schedule information database D320 and a matching information database D330 as functional components. The processor 301 of the server apparatus 300 performs processing in the running schedule information acquisition unit F310, processing in the desired schedule information acquisition unit F320, processing in the priority setting unit F330, processing in the matching processing unit F340 and processing in the matching information provision unit F350 according to respective computer programs in the main storage unit 302. However, any of the functional components or a part of the processing in any of the functional components may be provided or performed by a hardware circuit.

Each of the running schedule information database D310, the desired schedule information database D320 and the matching information database D330 is built by management of data stored in the auxiliary storage unit 303, by a program for a database management system (DBMS), the program being executed by the processor 301. Each of the running schedule information database D310, the desired schedule information database D320 and the matching information database D330 is, for example, a relational database.

Note that any of the functional components of the server apparatus 300 or a part of processing in any of the functional components may be provided or performed by another computer connected to the network N1. For example, processing in the matching processing unit F340 and processing in the running schedule information acquisition unit F310, the desired schedule information acquisition unit F320, the priority setting unit F330 and the matching information provision unit F350 may be performed by different computers.

The running schedule information acquisition unit F310 acquires running schedule information from a driving user who drives a vehicle provided for ride sharing. The running schedule information includes a departure point and a destination of the vehicle to be used for ride sharing, that is, a travel schedule of the driving user who drives the vehicle. Then, the running schedule information acquisition unit F310 registers the running schedule information in the running schedule information database D310.

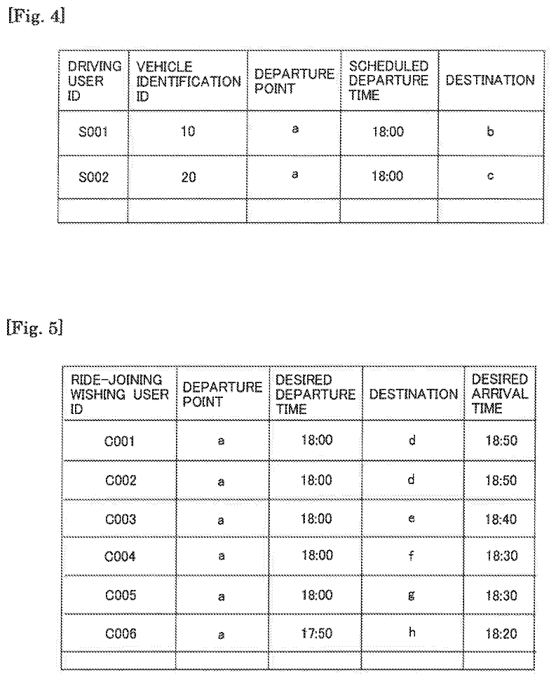

Here, the running schedule information database D310 is a database that stores running schedule information. The running schedule information database D310 includes a running schedule information table, which is illustrated in FIG. 4. Information stored in the running schedule information table is not limited to the example illustrated in FIG. 4 and appropriate addition, change and deletion of fields are possible.

The running schedule information table illustrated in FIG. 4 include fields of user ID (driving user ID), vehicle identification ID, departure point, scheduled departure time and destination. A driving user ID is an ID for identifying a driving user and is associated with a vehicle identification ID for identifying a vehicle in advance in the server apparatus 300. Also, ride-sharing user information including user IDs is managed in a separate table and the table include, e.g., contact information of each user. Examples of the contact information include a mobile phone number or an e-mail address of the user.

Such schedule information is transmitted from the driving user terminal 200 to the server apparatus 300 upon the driving user inputting the running schedule information to the driving user terminal 200. More specifically, the driving user terminal 200 includes a functional configuration that receives an input of running schedule information and transmits the input information to the server apparatus 300. The processor 201 of the driving user terminal 200 performs processing for transmitting running schedule information input from the input unit 205, to the server apparatus 300 via the communication unit 206, according to a computer program in the main storage unit 202. Then, the running schedule information acquisition unit F310 acquires the information transmitted from the driving user terminal 200.

Here, FIG. 3 is referred to again. The desired schedule information acquisition unit F320 acquires desired schedule information from a user wishing to join a ride in a vehicle provided for ride sharing as a non-driving user (ride-joining wishing user). Note that the desired schedule information includes a departure point and a destination of the ride-joining wishing user, that is, a schedule of travel using ride sharing, the schedule being desired by the ride-joining wishing user. Then, the desired schedule information acquisition unit F320 registers the desired schedule information in the desired schedule information database D320.

The desired schedule information database D320 is a database that stores desired schedule information. The desired schedule information database D320 includes a desired schedule information table, which is illustrated in FIG. 5. Information stored in the desired schedule information table is not limited to the example illustrated in FIG. 5 and appropriate addition, change and deletion of fields are possible.

The desired schedule information table illustrated in FIG. 5 includes fields of user ID (ride-joining wishing user ID), departure point, desired departure time, destination and desired arrival time.

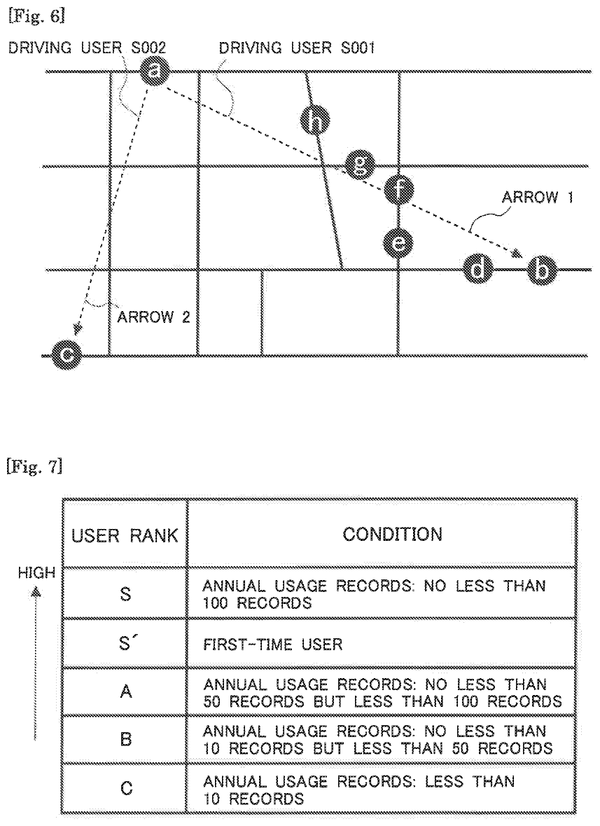

Here, the positional relationship of spots “a” to “h” indicated in FIGS. 4 and 5 is illustrated in FIG. 6. In the present embodiment, it can be seen that there are spots “d” to “h”, which are destinations of ride-joining wishing users, in a travel direction when driving user S001 travels from departure point “a” to destination “b” (the direction is indicated as arrow 1 in FIG. 6). On the other hand, there is no destination of a ride-joining wishing user in a travel direction when driving user S002 travels from departure point “a” to destination “c” (the direction is indicated as arrow 2 in FIG. 6).

In this case, according to matching processing using a known technique, since there are destinations of ride-joining wishing users C001 to C006 in the travel direction of driving user S001, ride-joining wishing users C001 to C006 can be matched with a vehicle 10 driven by driving user S001. In the present embodiment, the priority setting unit F330 illustrated in FIG. 3 first predicts whether or not a plurality of ride-joining wishing users can be matched with a first vehicle that is a vehicle corresponding to the vehicle. More specifically, the priority setting unit F330 predicts whether or not a plurality of ride-joining wishing users can be matched with the first vehicle, based on the running schedule information acquired by the running schedule information acquisition unit F310 and the desired schedule information pieces acquired by the desired schedule information acquisition unit F320.

If it is predicted that a plurality of ride-joining wishing users can be matched with the first vehicle, next, the priority setting unit F330 sets a predetermined priority for matching, for each of the plurality of ride-joining wishing users. This will be described with reference to FIGS. 7 to 9.

FIG. 7 is a diagram for describing user ranks given to users using the information processing system 1 according to the present embodiment. In the present embodiment, five user ranks are used and an ascending order of the rank is: C, B, A, S′, S. For each rank, a condition for providing the rank is provided, and for example, rank A is given to a user having an annual usage records of no less than 50 records but less than 100 records. Also, for example, rank S′ is given to a first-time user of the system.

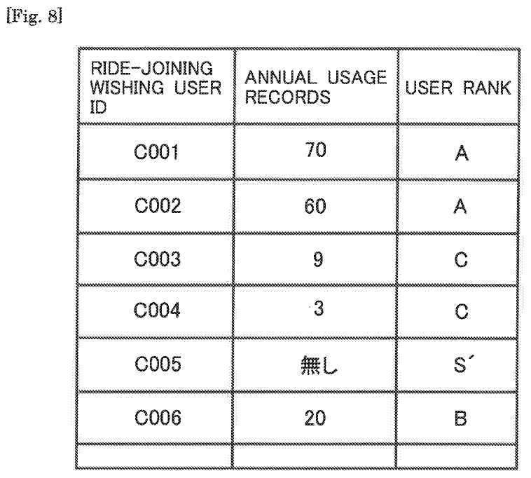

Then, in the present embodiment, since ride-joining wishing users C001 to C006 can be matched with the vehicle 10 (first vehicle) driven by driving user S001, the priority setting unit F330 sets a predetermined priority for matching, for each of the ride-joining wishing users, based on the user ranks determined in advance for ride-joining wishing users C001 to C006. Here, FIG. 8 is a diagram illustrating user ranks given to ride-joining wishing users C001 to C006. In the present embodiment, user rank A is given to user C001 having previous-year annual usage records of 70 records and user rank C is given to user C004 having previous-year annual usage records of three records. Also, user rank S′ is given to user C005, who is a first-time user of the system.

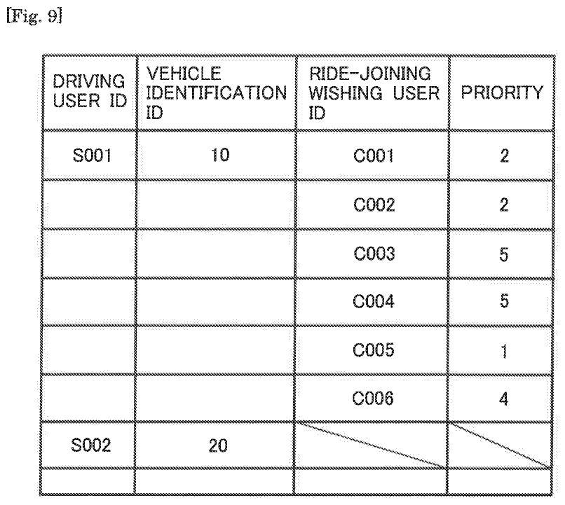

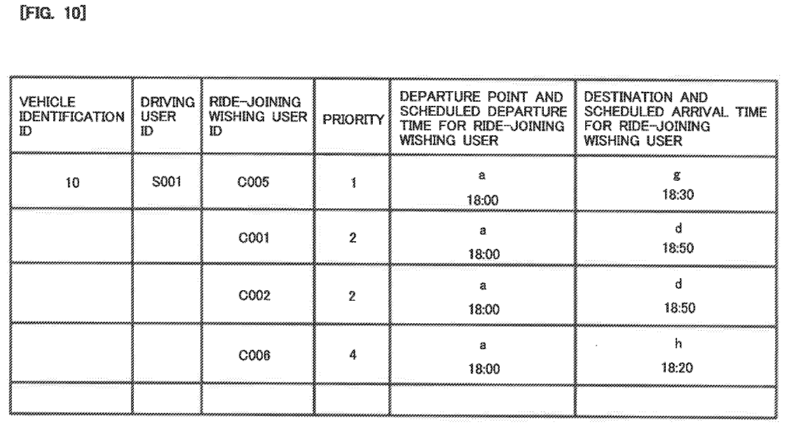

FIG. 9 is a diagram illustrating predetermined priorities set based on the user ranks illustrated in FIG. 8. As illustrated in FIG. 9, from among ride-joining wishing users C001 to C006, a priority of user C005 given the highest user rank is 1, and a priority of each of users C003, C004 given the lowest user rank is 5. Note that each of these priorities is an index indicating a degree of easiness of matching of a relevant one of a plurality of ride-joining wishing users with a vehicle.

Here, FIG. 3 is referred to again. The matching processing unit F340 performs matching between a first vehicle and a plurality of ride-joining wishing users based on respective predetermined priorities set for the ride-joining wishing users by the priority setting unit F330. More specifically, the matching processing unit F340 performs matching between the first vehicles and the ride-joining wishing users in such a manner that from among the plurality of ride-joining wishing users with the respective predetermined priorities set therefor, a user whose priority is high is matched with the first vehicle in preference to a user whose priority is lower. Note that the processor 301 functions as a controller according to the present disclosure by performing the processing in desired schedule information acquisition unit F320, the processing in the priority setting unit F330 and the processing in the matching processing unit F340. Then, the server apparatus 300 functions as an information processing apparatus according to the present disclosure.

Then, after performing matching between the first vehicle and the ride-joining wishing users, the matching processing unit F340 generates matching information. Here, the matching information is information to be registered in the matching information database D330.

The matching information database D330 is a database that stores matching information. The matching information database D330 includes a matching information table, which is illustrated in FIG. 10. Note that information stored in the matching information table is not limited to the example illustrated in FIG. 10 and appropriate addition, change and deletion of fields are possible.

The matching information table FIG. 10 include fields of vehicle identification ID, driving user ID, user ID of ride-joining wishing user matched with first vehicle, priority of ride-joining wishing user, departure point and scheduled departure time for ride-joining wishing user, and destination and scheduled arrival time for ride-joining wishing user. In the present example, ride-joining wishing users C005, C001, C002, C006 are matched with the vehicle 10 driven by driving user S001. Here, a riding capacity of the vehicle 10 is five people. Then, as described above with reference to FIG. 6, a number of ride-joining wishing users, the number being larger than a ride-sharing capacity of the vehicle (four people) (six people that are ride-joining wishing users C001 to C006), can be matched with the vehicle 10. Therefore, in the present example, as illustrated in FIG. 10, from among ride-joining wishing users C001 to C006, ride-joining wishing users C005, C001, C002, C006, who are top four users in priority, are matched with the vehicle 10.

Then, such matching information is provided to the driving user of the first vehicle and the ride-joining wishing users matched with the first vehicle, by the matching information provision unit F350 illustrated in FIG. 3. Also, each of the ride-joining wishing users not matched with the first vehicle is notified of the ride-joining wishing user being not matched with the first vehicle.

According to the information processing system described above, matching between a first vehicle and ride-joining wishing users is performed based on user ranks determined in advance. Here, each ride-joining wishing user can know his/her own user rank in advance (for example, the user rank is indicated when the ride-joining wishing user inputs desired schedule information from the predetermined app installed in his/her user terminal 100). Then, the ride-joining wishing user can grasp whether or not the ride-joining wishing user himself/herself is likely to be matched with a first vehicle in advance, and therefore, the worry the ride-joining wishing user has about whether or not he/she can travel using ride sharing is decreased. Also, with such system above, it is conceivable that users of ride sharing actively use ride sharing in order to raise their own user ranks, and as a result, use of ride sharing is promoted.

Here, in the present embodiment, in order to enable ride-joining wishing users C003, C004 not matched with the vehicle 10 (first vehicle) driven by user S001 to travel to the respective destinations using ride sharing, the matching processing unit F340 may perform matching between a vehicle 20 (second vehicle) driven by driving user S002 and users C003, C004. However, as described above with reference to FIG. 6, the destinations of users C003, C004 are not located in the travel direction of driving user S002. Therefore, when driving user S002 travels from departure point “a” to destination “c”, if driving user S002 travels via destination e of user C003 and destination f of user C004, driving user S002 takes a circuitous route.

Therefore, as a result of performing matching between a first vehicle and ride-joining wishing users based on respective predetermined priorities, if from among a plurality of ride-joining wishing users that can be matched with the first vehicle, there are excess users actually not matched with the first vehicle because of a limitation of a ride in the first vehicle due to a riding capacity of the first vehicle, the matching processing unit F340 may perform matching between a second vehicle that is a vehicle corresponding to the vehicle, the vehicle being different from the first vehicle, and the excess users so that the excess users can join a ride in the second vehicle for travel, by giving an incentive to a driving user of the second vehicle as compensation for sharing a ride with the excess users. In this case, the matching processing unit F340 may acquire the incentive given to the driving user of the second vehicle, from the excess users. Examples of the incentive include, e.g., points that can be used for a predetermined service, electronic data of a discount coupon or a gift certificate and electronic money. Such incentive data is transmitted from the server apparatus 300 to a driving user terminal 200 of the driving user of the second vehicle, and, for example, when the driving user of the second vehicle uses a predetermined facility, the driving user can receive a discount of a charge for using the facility, by making a discount coupon of the facility acquired as the incentive data be displayed on a display unit 204 of the driving user terminal 200.

In other words, in the present embodiment, an incentive is given to user S002 who is the driving user of the vehicle 20 (second vehicle), which is different from the vehicle 10 (first vehicle), as compensation for sharing a ride with users C003, C004, which are excess users. In this case, for example, an incentive corresponding to a transportation cost a fuel cost) for driving user S002 to take a circuitous route for travel is given to the driving user S002. Note that before performing matching between the vehicle 20 and excess users C003, C004, the matching processing unit F340 may present the content of the incentive to driving user S002 and excess users C003, C004 to request an approval of the matching from each of these uers.

According to the above, even if a user rank of a ride-joining wishing user is low, the ride-joining wishing user can user ride sharing at ease, and thus, use of ride sharing is promoted. Note that if the matching processing unit F340 fails to match ride-joining wishing users C003, C004 with a vehicle, the server apparatus 300 may perform processing for arranging a taxi for these users. This processing can also make the users have a sense of ease.

(Flow of Processing)

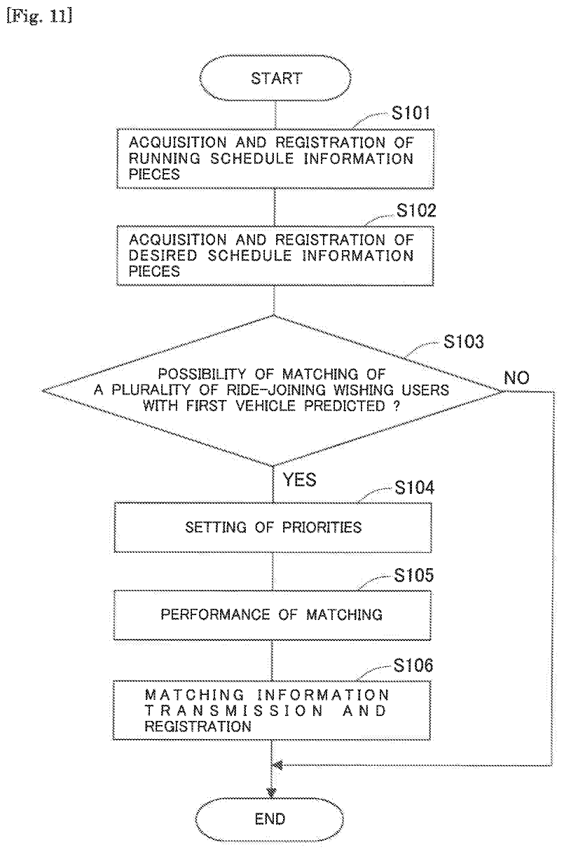

The flow of processing in the server apparatus 300 according to the present embodiment will be described, FIG. 11 is a flowchart of processing performed by the server apparatus 300.

In the processing in FIG. 11, first, in step S101, running schedule information pieces are acquired and the information pieces are registered. In step S101, the server apparatus 300 acquires a running schedule information piece transmitted from driving user terminals 200 through reception via the communication unit 304 and registers the running schedule information pieces in the running schedule information database D310.

Next, in step S102, desired schedule information pieces are acquired and the information pieces are registered. In step S102, the server apparatus 300 acquires desired schedule information pieces transmitted from user terminals 100 through reception via the communication unit 304 and registers the desired schedule information pieces in the desired schedule information database D320.

Next, in step S103, whether or not it is predicated that a plurality of ride-joining wishing users can be matched with a first vehicle is determined. In step S103, whether or not a plurality of ride-joining wishing users can be matched with the first vehicle is predicted based on the relevant running schedule information piece acquired in step S161 and the relevant desired schedule information pieces acquired in step S102, using a known technique. Then, if an affirmative determination is made in step S103, the processor 301 of the server apparatus 300 proceeds to processing in step S104, and if a negative determination is made in step S103, performance of the present flow ends.

If an affirmative determination is made in step S103, next, in step S104, a predetermined priority for matching is set for each of the plurality of ride-joining wishing users that can be matched with the first vehicle. In step S104, as described above, the predetermined priorities are set based on respective user ranks set in advance for the plurality of ride-joining wishing users.

Next, in step S105, matching between the first vehicle and the ride-joining wishing users is performed. In step S105, matching between the first vehicle and the ride-joining wishing users is performed in such a manner that from among the plurality of ride-joining wishing users with the respective priorities set therefor in step S104, a user whose priority is high is matched with the first vehicle in preference to a user whose priority is low. Then, in step S106, matching information of the matching according to the processing in step S105 is transmitted. In step S106, the server apparatus 300 transmits the matching information to respective user terminals 100 of ride-joining wishing users matched with the first vehicle and the driving user terminal 200. Then, the server apparatus 300 registers the matching information in the matching information database D330. The server apparatus 300 transmits a notice of a failure to be matched with the first vehicle to a user terminal 100 of a ride-joining wishing user not matched with the first vehicle. Then, after the processing in step S100, the execution of the present flow ends.

The above-described information processing system enables a ride-joining wishing user to grasp whether or not the ride-joining wishing user is likely to be matched with a first vehicle, based on the user's own user rank, and thus, the worry the ride-joining wishing user has in using ride sharing is decreased. In other words, the information processing apparatus according to the present disclosure enables provision of a form of transportation in which a plurality of users ride in a same vehicle for travel, the form of transportation being easy for a user to use.

(Recording Medium)

A program that causes a computer or another machine or apparatus (hereinafter, “computer or the like”) to provide any of the above-described functions can be stored in a storage medium that can be read by the computer or the like. The function can be provided by causing the computer or the like to read and execute the program in the storage medium.

Here, the storage medium that can be read by the computer or the like refers to a non-transitory storage medium that can store information such as data or a program by means of an electrical, magnetic, optical, mechanical or chemical action and allows the information to be read by the computer or the like. Examples of a storage medium that can be removed from the computer or the like from among such storage mediums include, e.g., a flexible disk, a magnetooptical disk, a CD-ROM, a CD-R/W, a DVD, a Blu-ray disk, a DAT, an 8 mm tape and a memory card such as a flash memory. Also, examples of a storage medium fixed in the computer or the like from among such storage mediums include, e.g., a hard disk and a ROM (read-only memory). Furthermore, an SSD (solid-state drive) can be used as a storage medium that can be removed from the computer or the like or a storage medium fixed in the computer or the like.

### Second Embodiment

Next, a second embodiment of the present disclosure will be described. In the present embodiment, detailed description of components that are substantially the same as those of the first embodiment and control processing that is substantially the same as that of the first embodiment will be omitted.

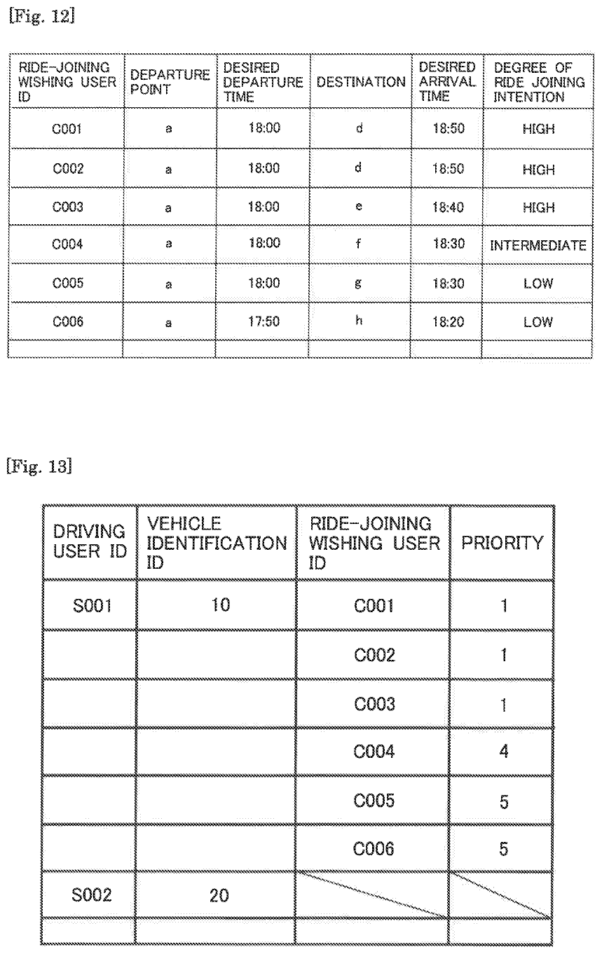

In the above-described first embodiment, the priority setting unit F330 of the server apparatus 300 sets predetermined priorities based on predetermined ranks set in advance for ride sharing users. On the other hand, in the present embodiment, a priority setting unit F330 of a server apparatus 300 sets predetermined priorities based on respective intention information pieces each relating to a predetermined intention indication, from a plurality of ride-joining wishing users that can be matched with a first vehicle. This will be described with reference to FIGS. 12 to 14.

FIG. 12 is a diagram illustrating a desired schedule information table in the present embodiment. The desired schedule information table illustrated in FIG. 12 includes fields of user ID (ride-joining wishing user ID), departure point, desired departure time, destination, desired arrival time and degree of intention of joining a ride. Here, the degree of intention of joining a ride is intention information relating to an indication of a predetermined intention from each of ride-joining wishing users and indicates the user's intention of joining a ride in a first vehicle in three levels of high, intermediate and low. The degree of intention of joining a ride is input by each ride-joining wishing user when the user inputs a departure point, a destination, etc., as desired schedule information using the predetermined app.

According to FIG. 12, it can be seen that ride-joining wishing users C001, C002, C003 each have a high intention of joining a ride and ride-joining wishing users C005, C006 each have a low intention of joining a ride. Here, a user having a high intention of joining a ride is, for example, a user wishing to join a ride in a first vehicle even at the cost of giving an incentive to a driving user of the first vehicle if a number of ride-joining wishing users, the number being larger than a ride-sharing capacity of the first vehicle, can be matched with the first vehicle. Also, a user having a low intention of joining a ride is, for example, a user having an intention of giving up a ride in a first vehicle to another user if a number of ride-joining wishing users, the number being larger than a ride-sharing capacity of the first vehicle, can be matched with the first vehicle.

Then, the priority setting unit F330 according to the present embodiment sets predetermined priorities based on the degrees of ride-joining intention illustrated in. FIG. 12. FIG. 13 is a diagram illustrating predetermined priorities in the present embodiment. As illustrated in FIG. 13, from among ride-joining wishing users C001 to C006, priorities of users C001, C002, C003 each having a high ride-joining intention are 1 and priorities of users C005, C006 each having a low ride-joining intention is 5. Then, a matching processing unit F340 performs matching between the first vehicle and the ride-joining wishing users based on the predetermined priorities set in such a manner as above. More specifically, the matching processing unit F340 performs matching between the first vehicle and the plurality of the ride-joining wishing users with the respective predetermined priorities set therefor in such a manner that from among the plurality of the ride-joining wishing users, a user whose priority is high is matched with the first vehicle in preference to a user whose priority is low,

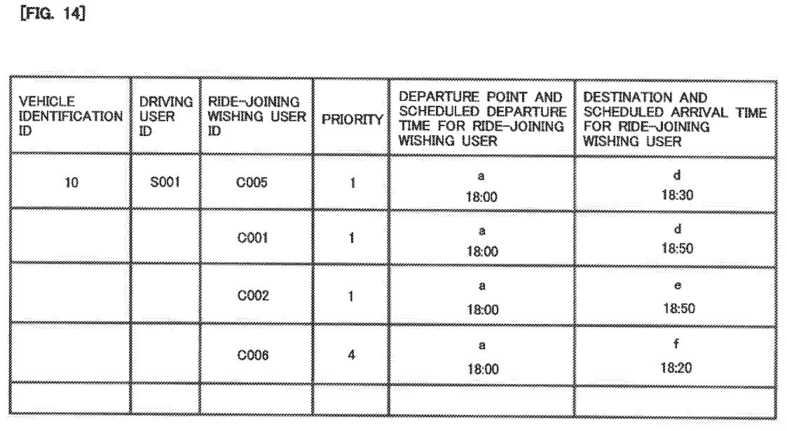

FIG. 14 is a diagram illustrating an example of a matching information table in the present embodiment. The matching information table illustrated in FIG. 14 includes fields of vehicle identification ID, driving user ID, user ID of ride-joining wishing user matched with first vehicle, priority of ride-joining wishing user, departure point and scheduled departure time for ride-joining wishing user and destination and scheduled arrival time for ride-joining wishing user. As in the description of the first embodiment, a ride-sharing capacity of the vehicle 10 is four people. Therefore, in the present example, as illustrated in FIG. 14, from among ride-joining wishing users C001 to C006, ride-joining wishing users C001, C002, C003, C004, who are top four in priority, are matched with the vehicle 10.

Accordingly, a ride-joining wishing user can grasp whether or not the ride-joining wishing user is likely to be matched with a first vehicle, based on an indication of his/her own intension, and thus, the worry the ride-joining wishing user has in using ride sharing is decreased. Consequently, a form of transportation in which a plurality of users ride in a same vehicle for travel, the form of transportation being easy for a user to use, can be provided.

Here, for example, where a schedule planed by a ride-joining wishing user himself/herself is fluid, even if the user is matched with a first vehicle, the matching may be cancelled later by the user. However, in such situation, it is conceivable that a ride-joining wishing user whose schedule is fluid does not indicate an intention of giving up a ride in a first vehicle to another user from the beginning. Therefore, in the present embodiment, the matching processing unit F340 may give an incentive to, from among a plurality of ride-joining wishing users with respective predetermined priorities set therefor, a user not matched with a first vehicle, the user indicating an intention of giving up a ride in the first vehicle to another user in desired schedule information (user having a low ride-joining intention). Examples of the incentive include, e.g., points that can be used for a predetermined service, electronic data of a discount coupon or a gift certificate and electronic money. Such incentive data is transmitted from the server apparatus 300 to a user terminal 100 of the ride-joining wishing user.

Then, for example, a ride-joining wishing user whose schedule is fluid is more likely to indicate an intention of giving up a ride in a first vehicle to another user from the beginning. Consequently, use of ride sharing is promoted.

### Other Embodiments

Each of the above-described embodiments is a mere example and the present disclosure can be carried out with appropriate change made thereto without departing from the spirit of the disclosure.

Also, the processing and configurations described in the present disclosure can freely be combined as long as such combination causes no technical contradiction.

Also, the processing described as processing performed by a single apparatus may be shared and performed by a plurality of apparatuses. Alternatively, the processing described as processing performed by different apparatuses may be performed by a single apparatus. In a computer system, what hardware configuration (server configuration) to be employed to provide the respective functions can flexibly be changed.

The present disclosure can also be carried out by supplying computer programs providing the functions described in the above embodiments to a computer and causing one or more processors included in the computer to read and execute the programs. Such computer programs may be provided to the computer via a non-transitory computer-readable storage medium that is connectable to a system bus of the computer or may be provided to the computer via a network. Examples of the non-transitory computer-readable storage medium include arbitrary types of disks including magnetic disks (e.g., a floppy (registered trademark) disk and a hard disk drive (HDD)) and optical disks (e.g., a CD-ROM, a DVD disk and a Blu-ray disk), a read-only memory (ROM), a random access memory (RAM), an EPROM, an EEPROM, a magnetic card, a flash memory, an optical card, and an arbitrary type of medium suitable for storing electronic instruction.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. An information processing apparatus for, in a form of transportation in which a plurality of users ride in a same vehicle for travel, performing matching between the vehicle and ride-joining wishing users each wishing to join a ride in the vehicle as a non-driving user, the information processing apparatus comprising a controller which includes at least one processor,
the controller configured to:
for each of the ride-joining wishing users, acquire a schedule information piece relating to travel using the form of transportation, the travel being desired by the user;
if it is predicted that a plurality of the ride-joining wishing users can be matched with a first vehicle that is a vehicle corresponding to the vehicle, based on the schedule information pieces, set a predetermined priority for the matching, for each of the plurality of ride-joining wishing users; and
perform matching between the first vehicle and the ride-joining wishing users in such a manner that from among the plurality of ride-joining wishing users with the respective predetermined priorities set therefor, a user whose priority is high, is matched with the first vehicle in preference to a user whose priority is low.

2. The information processing apparatus according to claim 1,
wherein the controller sets the predetermined priorities based on respective predetermined ranks set in advance for users of the form of transportation.

3. The information processing apparatus according to claim 1,
wherein the controller sets the predetermined priorities based on respective intention information pieces each relating to a predetermined intention indication, from the plurality of ride-joining wishing users that can be matched with the first vehicle.

4. The information processing apparatus according to claim 3,
wherein the controller is further configured to give an incentive to, from among the plurality of ride-joining wishing users with the respective predetermined priorities set therefore, a user not matched with the first vehicle, the user indicating an intention of giving up a ride in the first vehicle to another user in the relevant intention information piece.

5. The information processing apparatus according to claim 1,
wherein as a result of performing matching between the first vehicle and the ride-joining wishing user based on the predetermined priorities, if from among the plurality of ride-joining wishing users that can be matched with the first vehicle, there is an excess user not actually matched with the first vehicle because of a limitation of a ride in the first vehicle due to a riding capacity of the first vehicle,
the controller is further configured to:
perform matching between a second vehicle that is a vehicle corresponding to the vehicle, the vehicle being different from the first vehicle, and the excess user so that the excess user can ride in the second vehicle for travel, by giving an incentive to a driving user of the second vehicle as compensation for sharing a ride with the excess user; and
acquire the incentive to be given to the driving user of the second vehicle, from the excess user.

6. The information processing apparatus according to claim 2,
wherein as a result of performing matching between the first vehicle and the ride-joining wishing user based on the predetermined priorities, if from among the plurality of ride-joining wishing users that can be matched with the first vehicle, there is an excess user not actually matched with the first vehicle because of a limitation of a ride in the first vehicle due to a riding capacity of the first vehicle,
the controller is further configured to:
perform matching between a second vehicle that is a vehicle corresponding to the vehicle, the vehicle being different from the first vehicle, and the excess user so that the excess user can ride in the second vehicle for travel, by giving an incentive to a driving user of the second vehicle as compensation for sharing a ride with the excess user; and
acquire the incentive to be given to the driving user of the second vehicle, from the excess user.

7. An information processing method for, in a form of transportation in which a plurality of users ride in a same vehicle for travel, performing matching between the vehicle and ride-joining wishing users each wishing to join a ride in the vehicle as a non-driving user,
the information processing method causing a computer to execute the steps of:
for each of the ride-joining wishing users, acquiring a schedule information pike relating to travel using the form of transportation, the travel being desired by the user;
if it is predicted that a plurality of the ride-joining wishing users can be matched with a first vehicle that is a vehicle corresponding to the vehicle, based on the schedule information pieces, setting a predetermined priority for the matching, for each of the plurality of ride-joining wishing users; and
performing matching between the first vehicle and the ride-joining wishing users in such a manner that from among the plurality of ride-joining wishing users with the respective predetermined priorities set therefor, a user whose priority is high, is matched with the first vehicle in preference to a user whose priority is low.

8. A non-transitory storage medium storing a program for, in a form of transportation in which a plurality of users ride in a same vehicle for travel, performing matching between the vehicle and ride-joining wishing users each wishing to join a ride in the vehicle as a non-driving user,
the program causing a computer to execute the steps of:
for each of the ride-joining wishing users, acquiring a schedule information piece relating to travel using the form of transportation, the travel being desired by the user;
if it is predicted that a plurality of the ride-joining wishing users can be matched with a first vehicle that is a vehicle corresponding to the vehicle, based on the schedule information pieces, setting a predetermined priority for the matching, for each of the plurality of ride-joining wishing users; and
performing matching between the first vehicle and the ride-joining wishing users in such a manner that from among the plurality of ride-joining wishing users with the respective predetermined priorities set therefor, a user whose priority is high, is matched with the first vehicle in preference to a user whose priority is low.
